(19) United States
(12) Patent Application Publication
(10) Pub. No.: US 2025/0304046 A1
(43) Pub. Date: Oct. 2, 2025

(54) VEHICLE CONTROL DEVICE AND VEHICLE CONTROL METHOD

(71) Applicant: HONDA MOTOR CO., LTD., Tokyo (JP)

(72) Inventors: Shinya Sato, Tokyo (JP); Shunya Ishikawa, Tokyo (JP)

(73) Assignee: HONDA MOTOR CO., LTD., Tokyo (JP)

(21) Appl. No.: 19/063,351

(22) Filed: Feb. 26, 2025

(30) Foreign Application Priority Data
Mar. 26, 2024 (JP) 2024-049520

(51) Int. Cl. B60W 30/09; B60W 10/18; B60W 30/095; B60W 50/00; B60W 50/14; G06V 20/58

(52) U.S. Cl. CPC B60W 30/09; B60W 10/18; B60W 30/0956; B60W 50/0097; B60W 50/14; G06V 20/58; B60W 2050/143; B60W 2050/146; B60W 2420/403; B60W 2420/408; B60W 2520/10; B60W 2554/4026; B60W 2554/4042; B60W 2554/4045; B60W 2554/802

(57) ABSTRACT

A vehicle control device includes: a recognition unit configured to recognize surroundings of a host vehicle; and a control unit configured to perform at least one of: notifying a driver of the host vehicle; and braking the host vehicle, in a case where a determination is made, from a recognition result of the recognition unit, that a two-wheeled vehicle and an obstacle are present outside a predicted trajectory of the host vehicle in front of the host vehicle and the two-wheeled vehicle is traveling between the host vehicle and the obstacle toward the obstacle.

### CROSS-REFERENCE TO RELATED APPLICATION

This application is based on and claims priority under 35 USC 119 from Japanese Patent Application No. 2024-049520 filed on Mar. 26, 2024.

### TECHNICAL FIELD

The present invention relates to a vehicle control device and a vehicle control method.

### BACKGROUND ART

In recent years, efforts have been actively made to provide access to a sustainable transportation system in consideration of vulnerable people among traffic participants. In order to implement the above, focus has been placed on research and development on further improving safety and convenience of traffic by research and development related to prevention safety technique.

For example, Patent Literature 1 discloses a driving assistance control device for controlling traveling of a vehicle when a collision with an object may occur. Specifically, Patent Literature 1 discloses that, regarding an object such as a two-wheeled vehicle present on a lateral side of a preceding vehicle in a stopped state, when it is determined that a host vehicle cannot be stopped just before the object and a collision or contact with the object cannot be avoided, a CPU determines a target position on a road on which the host vehicle travels to be a width-direction center position of a rear portion of the preceding vehicle.

### PATENT LITERATURE

Patent Literature 1: JP2019-166870A

### SUMMARY OF INVENTION

Patent Literature 1 discloses a technique for avoiding, when an object such as a two-wheeled vehicle is already present on a lateral side of a preceding vehicle in a stopped state, a collision or contact between a host vehicle and the object, but there is no disclosure regarding a case where an object traveling just before the preceding vehicle in a stopped state jumps into a lane of the host vehicle, and there is a room for discussion on this point.

The present invention is to provide a vehicle control device and a vehicle control method capable of performing appropriate driving assistance when a two-wheeled vehicle traveling just before an obstacle may enter a predicted trajectory of a host vehicle. This contributes to development of a sustainable transportation system.

A vehicle control device according to an aspect of the present invention includes a recognition unit configured to recognize surroundings of a host vehicle; and a control unit configured to perform at least one of notifying a driver of the host vehicle and braking the host vehicle when it is determined, from a recognition result of the recognition unit, that a two-wheeled vehicle and an obstacle are present outside a predicted trajectory of the host vehicle in front of the host vehicle and the two-wheeled vehicle is traveling toward the obstacle between the host vehicle and the obstacle.

Further, a vehicle control method according to an aspect of the present invention includes: recognizing surroundings of a host vehicle; and performing at least one of notifying a driver of the host vehicle and braking the host vehicle when it is determined, from a recognition result, that a two-wheeled vehicle and an obstacle are present outside a predicted trajectory of the host vehicle in front of the host vehicle and the two-wheeled vehicle is traveling toward the obstacle between the host vehicle and the obstacle.

According to the present invention, appropriate driving assistance can be performed when a two-wheeled vehicle traveling just before an obstacle may enter the predicted trajectory of the host vehicle.

### BRIEF DESCRIPTION OF DRAWINGS

FIG. 1 is a block diagram showing an internal configuration of a vehicle equipped with a vehicle control device according to an embodiment of the present invention.

FIG. 2 is a diagram showing an example of a situation in which the vehicle control device performs collision mitigation brake control.

FIG. 3 is a flowchart of the collision mitigation brake control performed by the vehicle control device in the situation shown in FIG. 2.

FIG. 4 is a diagram showing another example of the situation in which the vehicle control device performs the collision mitigation brake control.

### DETAILED DESCRIPTION OF THE INVENTION

Hereinafter, a vehicle control device and a vehicle control method according to an embodiment of the present invention will be described with reference to the accompanying drawings.

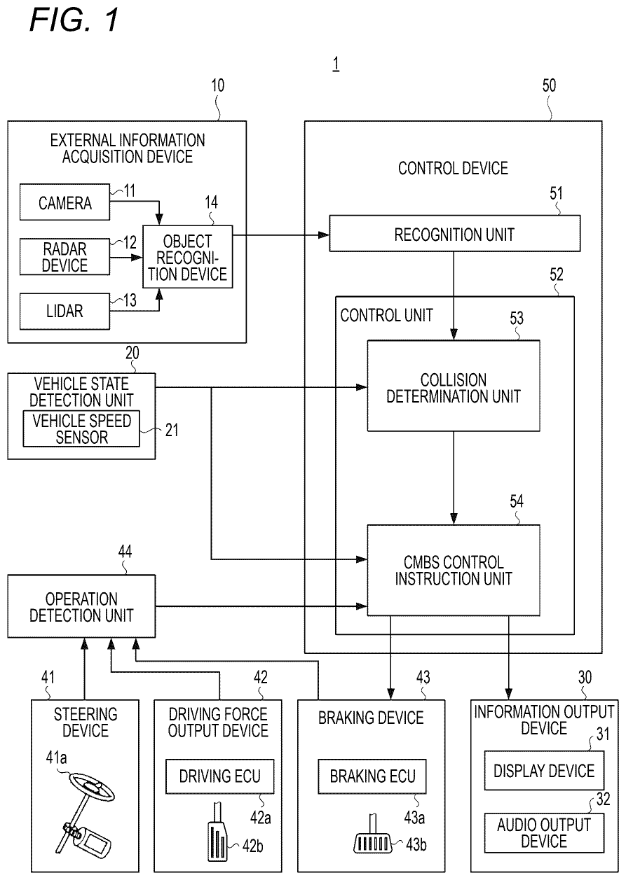

FIG. 1 is a block diagram showing an internal configuration of a vehicle 1. The vehicle 1 includes, for example, an external information acquisition device 10, a vehicle state detection unit 20, an information output device 30, a steering device 41, a driving force output device 42, a braking device 43, an operation detection unit 44, and a control device 50. These devices and units are connected to one another by a multiplex communication line such as a controller area network (CAN) communication line, a serial communication line, or a wireless communication network.

The external information acquisition device 10 is a device that acquires information around the vehicle 1, and includes, for example, a camera 11, a radar device 12, a light detection and ranging (LIDAR) 13, and an object recognition device 14. Each of the camera 11, the radar device 12, and the LIDAR 13 are attached to any position of the vehicle 1.

The camera 11 is, for example, a digital camera using an imaging element such as a charge coupled device (CCD) or a complementary metal oxide semiconductor (CMOS).

The radar device 12 emits radio waves such as millimeter waves around the vehicle 1, and detects radio waves (reflected waves) reflected by an object to detect at least a position (distance and orientation) of the object.

The LIDAR 13 emits light (or an electromagnetic wave having a wavelength close to that of light) around the vehicle 1 and measures scattered light. The LIDAR 13 detects a distance to a target based on a time elapsed from light emission to light reception. The emitted light is, for example, pulsed laser light.

The object recognition device 14 performs sensor fusion processing on a part or all of detection results of the camera 11, the radar device 12, and the LIDAR 13 to recognize a position, a type, a speed, and the like of an object. The object recognition device 14 outputs a recognition result to the control device 50. The object recognition device 14 may output the detection results of the camera 11, the radar device 12, and the LIDAR 13 to the control device 50 as they are.

The vehicle state detection unit 20 includes, for example, a vehicle speed sensor 21. The vehicle speed sensor 21 includes a speed sensor that detects a travel speed of the vehicle 1, an acceleration sensor that detects an acceleration, a yaw rate sensor that detects an angular velocity around a vertical axis, an azimuth sensor that detects an orientation of the vehicle 1, and the like.

The information output device 30 is a device that notifies an occupant including a driver of predetermined information, and includes, for example, a display device 31 and an audio output device 32. The display device 31 includes a head up display or a display device provided on an instrument panel, and visually notifies information. The audio output device 32 includes a speaker or the like attached to any position in the vehicle, and notifies information by audio. The information output device 30 may include a vibration device that notifies predetermined information by vibration.

The steering device 41 is an operator for receiving a steering operation. The steering device 41 includes, for example, a steering wheel 41a and a steering angle sensor (not shown) that detects a steering angle of the steering wheel 41a.

The driving force output device 42 outputs, to driving wheels, a travel driving force (torque) for driving the vehicle 1 to travel. The driving force output device 42 includes, for example, a combination of an internal combustion engine, an electric motor, a transmission, or the like, and a driving electronic control unit (ECU) 42a that controls the combination. The driving ECU 42a controls the above-described configuration according to information received from the control device 50 or information received from an accelerator pedal 42b.

The braking device 43 includes, for example, a brake caliper, a cylinder that transmits a hydraulic pressure to the brake caliper, and an electric motor that generates the hydraulic pressure in the cylinder. Further, the braking device 43 includes a braking ECU 43a and performs braking force control of the vehicle 1. The braking ECU 43a controls the electric motor based on a brake operation of a user on the brake pedal 43b or an instruction from the control device 50 and outputs a brake torque corresponding to the brake operation to each wheel. In this way, the braking force of the vehicle 1 is controlled.

The operation detection unit 44 detects driving operations input from the steering device 41, the driving force output device 42, and the braking device 43.

The control device 50 is implemented by a computer (for example, an ECU) including a central processing unit (CPU) that performs various types of calculation, a storage device that stores various types of information, and an input and output device that controls input and output of data between inside and outside of the control device 50. A function of the control device 50 may be implemented by, for example, the CPU executing a predetermined control program stored in advance in the storage device. In addition, a part or all of functions of the control device 50 may be implemented by hardware such as a large-scale integration (LSI), an application-specific integrated circuit (ASIC), a field-programmable gate array (FPGA), or a graphics processing unit (GPU). Further, a part or all of functions of the control device 50 may be implemented by cooperation of software and hardware. The number of computers constituting the control device 50 can be appropriately designed.

The control device 50 performs control related to driving assistance including autonomous driving of the vehicle 1 (autonomous traveling of the vehicle 1 without an operation of the driver). The control related to the driving assistance that can be performed by the control device 50 includes a collision mitigation brake control system (also referred to as “CMBS”). In the collision mitigation brake control, in a case where there is a high probability of a collision with an object in front, the driver is warned by audio or the like and/or the braking device 43 is operated, and avoidance and mitigation of the collision between the vehicle 1 and the object are assisted.

The control device 50 includes, for example, a recognition unit 51 and a control unit 52.

The recognition unit 51 recognizes a surrounding situation of the vehicle 1 based on information received from the camera 11, the radar device 12, and the LIDAR 13 via the object recognition device 14. Specifically, the recognition unit 51 recognizes a position of an object around the vehicle 1, and a traveling state of the object such as a speed, and an acceleration.

The control unit 52 includes a collision determination unit 53 and a CMBS control instruction unit 54. The collision determination unit 53 determines, when an object is present in front of the vehicle 1, whether the vehicle 1 collides with the object based on a recognition result of the recognition unit 51. When it is determined that a collision between the vehicle 1 and the object may occur, the CMBS control instruction unit 54 performs the CMBS control, and notifies the driver of the possibility of the collision between the vehicle 1 and the object via the information output device 30, and/or issues a braking instruction to the braking device 43. Accordingly, the CMBS control instruction unit 54 can prompt the driver to perform a brake operation for avoiding the collision or can actually operate the braking device 43 to avoid the collision.

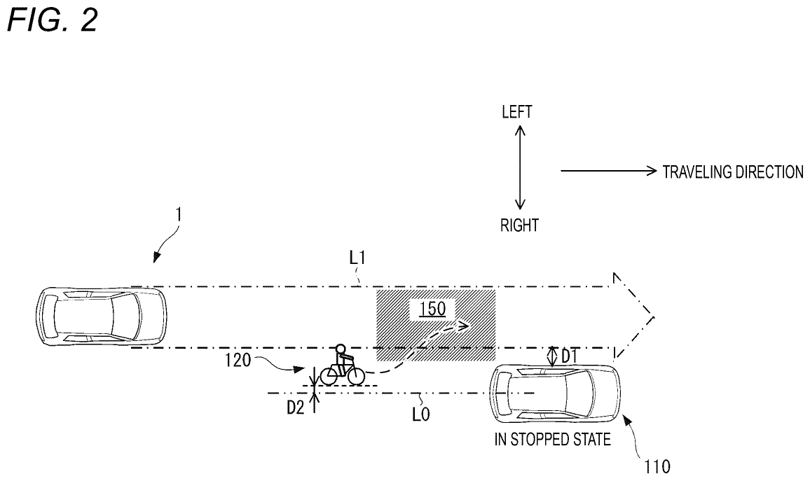

FIG. 2 is a diagram showing an example of a situation in which CMBS control is performed by the control device 50. Hereinafter, the vehicle 1 equipped with the control device 50 is also referred to as a host vehicle 1. Further, a direction in which the host vehicle 1 travels is referred to as a traveling direction, and a direction orthogonal to the traveling direction is referred to as a left-right direction.

In the example shown in FIG. 2, the host vehicle 1 is traveling on a road in the traveling direction in the drawing, and a preceding vehicle 110 is stopped in front of the host vehicle 1. For example, the preceding vehicle 110 is stopped on a shoulder of the road and is stopped in front of and on a right side of the host vehicle 1. Here, a distance between the host vehicle 1 and the preceding vehicle 110 in the left-right direction is denoted by a reference numeral D1. The distance D1 is a distance between a right end of the host vehicle 1 and a left end of the preceding vehicle 110 in the left-right direction. A two-wheeled vehicle 120 is traveling in the traveling direction ahead of the host vehicle 1 and behind the preceding vehicle 110. The two-wheeled vehicle 120 is traveling on a host vehicle 1 side (here, a left side) of a center of the preceding vehicle 110 in the left-right direction. The two-wheeled vehicle 120 is, for example, a bicycle, and is a moving object smaller than the preceding vehicle 110. Thus, the external information acquisition device 10 acquires information of both the preceding vehicle 110 and the two-wheeled vehicle 120 present in front of the host vehicle 1. Here, a line (two-dot chain line in the drawing) extending in the traveling direction and passing through the center of the preceding vehicle 110 in the left-right direction is denoted by a reference numeral L0, and a distance between the two-wheeled vehicle 120 and the center of the preceding vehicle 110 in the left-right direction is denoted by a reference numeral D2. The distance D2 is a distance between a right end of the two-wheeled vehicle 120 in the left-right direction and the line L0.

When the two-wheeled vehicle 120 is traveling in the traveling direction, the stopped preceding vehicle 110 is an obstacle, and the two-wheeled vehicle 120 may jump out to a lateral side of the preceding vehicle 110. At this time, when a position of the two-wheeled vehicle 120 when moving to the lateral side of the preceding vehicle 110 overlaps a predicted trajectory L1 of the host vehicle 1 (a one-dot chain line in the drawing), the host vehicle 1 and the two-wheeled vehicle 120 may collide with each other.

Therefore, when it is determined from the recognition result of the recognition unit 51 that the two-wheeled vehicle 120 and an obstacle (here, the stopped preceding vehicle 110) are present outside the predicted trajectory L1 of the host vehicle 1 in front of the host vehicle 1 and the two-wheeled vehicle 120 is traveling toward the obstacle between the host vehicle 1 and the obstacle, the control device 50 performs the CMBS control, specifically, notifies the driver of the host vehicle 1 and/or brakes the host vehicle 1. Accordingly, when the two-wheeled vehicle 120 has a high probability of entering the predicted trajectory L1 of the host vehicle 1, the control device 50 can warn the driver of the host vehicle 1 or perform appropriate deceleration assistance.

It is preferable to further set a condition for performing the CMBS control such that the CMBS control can be performed in an appropriate situation. Accordingly, excessive execution of the CMBS control can be reduced.

Specifically, the control device 50 preferably determines whether to perform the CMBS control, based on information related to a speed or a deceleration of the two-wheeled vehicle 120.

As an example, when it is further determined that the two-wheeled vehicle 120 is traveling at a speed equal to or larger than a predetermined threshold, the control device 50 may notify the driver of the host vehicle 1 and/or brake the host vehicle 1. In this case, since the two-wheeled vehicle 120 cannot be stopped just before the obstacle and has a high probability of entering the predicted trajectory L1 of the host vehicle 1, the driver of the host vehicle 1 is warned in advance or appropriate deceleration assistance is performed.

As another example, when it is further determined that a deceleration required for the two-wheeled vehicle 120 to stop with respect to the obstacle is equal to or larger than a predetermined threshold (for example, 0.3 m/s²), the control device 50 may notify the driver of the host vehicle 1 and/or brake the host vehicle 1. As described above, in a case where the two-wheeled vehicle 120 cannot be stopped with respect to the obstacle unless the two-wheeled vehicle 120 suddenly decelerates, the two-wheeled vehicle has a high probability of entering the predicted trajectory L1 of the host vehicle 1, and thus the driver of the host vehicle 1 is warned in advance or appropriate deceleration assistance is performed.

The “speed” and the “deceleration” described above may be either an absolute speed/absolute deceleration of the two-wheeled vehicle 120 or a relative speed/relative deceleration between the host vehicle 1 and the two-wheeled vehicle 120.

The control device 50 preferably determines whether to perform the CMBS control, based on information related to the distance between the two-wheeled vehicle 120 and the obstacle.

As an example, when it is further determined that the two-wheeled vehicle 120 is present within a predetermined range with respect to the obstacle, the control device 50 may notify the driver of the host vehicle 1 and/or brake the host vehicle 1. The predetermined range means, for example, that the distance between the two-wheeled vehicle 120 and the obstacle in the traveling direction is within a predetermined threshold. In this case, since the two-wheeled vehicle 120 has a high probability of entering the predicted trajectory L1 of the host vehicle 1, the driver of the host vehicle 1 is warned in advance or appropriate deceleration assistance is performed.

As an example, when it is further determined that the two-wheeled vehicle 120 is traveling on the host vehicle 1 side with respect to the center of the obstacle in the left-right direction, the control device 50 may notify the driver of the host vehicle 1 and/or brake the host vehicle 1. When the two-wheeled vehicle 120 is traveling on a side opposite to the host vehicle 1 with respect to the center of the obstacle in the left-right direction, the two-wheeled vehicle 120 has a high probability of avoiding from the opposite side to the lateral side of the obstacle, but when the two-wheeled vehicle 120 is traveling on the host vehicle 1 side with respect to the center of the obstacle in the left-right direction, the two-wheeled vehicle 120 has a high probability of entering the predicted trajectory L1 of the host vehicle 1. Thus, the driver of the host vehicle 1 is warned in advance or appropriate deceleration assistance is performed.

The control device 50 may be configured to notify the driver of the host vehicle 1 and/or brake the host vehicle 1 when the two-wheeled vehicle 120 is separated from the center of the obstacle in the left-right direction toward the host vehicle 1 by a distance equal to or larger than a predetermined threshold (for example, 0.2m). Accordingly, the CMBS control can be performed when there is a higher probability of entering the predicted trajectory L1 of the host vehicle 1.

Further, the control device 50 preferably determines whether to perform the CMBS control, based on information related to a speed or a deceleration of the host vehicle 1.

As an example, when it is further determined that the host vehicle 1 is traveling at a speed equal to or larger than a predetermined threshold, the control device 50 may notify the driver of the host vehicle 1 and/or brake the host vehicle 1. In this case, since there is a high probability that the two-wheeled vehicle 120 and the host vehicle 1 excessively approach each other when the two-wheeled vehicle 120 enters the predicted trajectory L1 of the host vehicle 1, the driver of the host vehicle 1 is warned in advance or appropriate deceleration assistance is performed.

As another example, when it is further determined that a deceleration required for the host vehicle 1 to stop with respect to the obstacle or a jumping-out prediction area 150 is equal to or larger than a predetermined threshold, the control device 50 may notify the driver of the host vehicle 1 and/or brake the host vehicle 1. The jumping-out prediction area 150 is a range in which the two-wheeled vehicle 120 may enter the predicted trajectory L1 of the host vehicle 1, and is, for example, a predetermined region including a region behind the obstacle and on the predicted trajectory L1 of the host vehicle 1. In such a case, since the host vehicle 1 cannot be stopped with respect to the obstacle or the jumping-out prediction area 150 unless the host vehicle 1 suddenly decelerates, there is a high probability that the host vehicle 1 and the two-wheeled vehicle 120 excessively approach each other. Thus, the driver of the host vehicle 1 is warned in advance or appropriate deceleration assistance is performed.

The “speed” and the “deceleration” described above may be either an absolute speed/absolute deceleration of the host vehicle 1 or a relative speed/relative deceleration between the host vehicle 1 and the two-wheeled vehicle 120.

Further, the control device 50 preferably determines whether to perform the CMBS control, based on information related to the distance between the host vehicle 1 and the obstacle (preceding vehicle 110) or the jumping-out prediction area 150.

As an example, when it is further determined that the host vehicle 1 is present within a predetermined range with respect to the obstacle or the jumping-out prediction area 150, the control device 50 may notify the driver of the host vehicle 1 and/or brake the host vehicle 1. The predetermined range means, for example, that the distance between the host vehicle 1 and the obstacle or the distance between the host vehicle 1 and the jumping-out prediction area 150 in the traveling direction is within a predetermined threshold. In such a case, since there is a high probability that the host vehicle 1 and the two-wheeled vehicle 120 excessively approach each other, the driver of the host vehicle 1 is warned in advance or appropriate deceleration assistance is performed.

As another example, when it is further determined that the distance D1 between the predicted trajectory L1 of the host vehicle 1 and the obstacle in the left-right direction is equal to or less than a predetermined threshold, the control device 50 may notify the driver of the host vehicle 1 and/or brake the host vehicle 1. The predetermined threshold is, for example, a gap (for example, 0.5 m) that allows the two-wheeled vehicle 120 to pass beside the obstacle without entering the predicted trajectory L1 of the host vehicle 1. When the distance D1 is equal to or less than the predetermined threshold, since the two-wheeled vehicle 120 has a high probability of entering the predicted trajectory L1 of the host vehicle 1, the driver of the host vehicle 1 is warned in advance or appropriate deceleration assistance is performed. In a case where a condition for performing the CMBS control is that the host vehicle 1 and the obstacle overlap each other when viewed from a front-rear direction, the predetermined threshold may be set to 0 m or less.

When the control device 50 determines whether to perform the CMBS control, the plurality of conditions described above may be freely combined, and a combination method and the number of conditions may be freely set.

Further, the control device 50 may be configured not to notify the driver of the host vehicle 1 and/or brake the host vehicle 1 when the operation detection unit 44 detects the brake operation from the driver of the host vehicle 1, for example, even in a case where the obstacle is present in front of the host vehicle 1 and the two-wheeled vehicle 120 is traveling between the host vehicle 1 and the obstacle toward the obstacle.

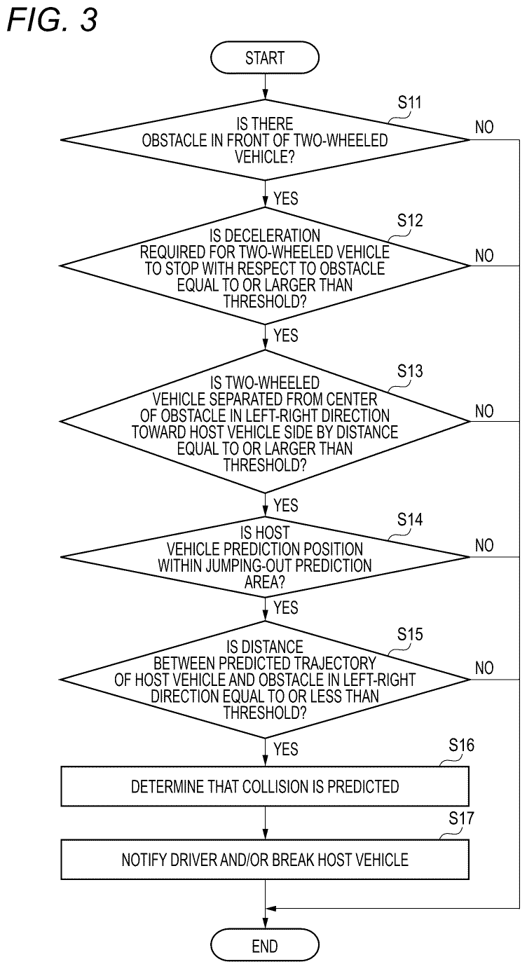

FIG. 3 shows a flowchart of the CMBS control performed by the control device 50 in the situation shown in FIG. 2. The flowchart is an example, and a condition for performing the CMBS control can be added, changed, and/or deleted as appropriate, and an order of each step can also be freely changed.

First, the control device 50 determines whether there is an obstacle in front of the two-wheeled vehicle 120, based on the recognition result of the recognition unit 51 (step S11).

When it is determined that there is no obstacle, specifically, the preceding vehicle 110 in front of the two-wheeled vehicle 120 (step S11: NO), the control device 50 determines that the two-wheeled vehicle 120 does not enter the predicted trajectory L1 of the host vehicle 1, and ends the flowchart without performing the CMBS control.

When it is determined that the obstacle is present in front of the two-wheeled vehicle 120 (step S11: YES), the control device 50 determines whether the deceleration required for the two-wheeled vehicle 120 to stop with respect to the obstacle is equal to or larger than the predetermined threshold, based on the recognition result of the recognition unit 51 (step S12). When the deceleration is equal to or larger than the predetermined threshold, the two-wheeled vehicle 120 cannot be stopped just before the obstacle and has a high probability of entering the predicted trajectory L1 of the host vehicle 1, and when the deceleration is less than the predetermined threshold, the two-wheeled vehicle 120 stops just before the obstacle and has a low a probability of entering the predicted trajectory L1 of the host vehicle 1.

When the deceleration is less than the predetermined threshold (step S12: NO), the control device 50 determines that the two-wheeled vehicle 120 does not enter the predicted trajectory L1 of the host vehicle 1, and ends the flowchart without performing the CMBS control.

When it is determined that the deceleration is equal to or larger than the predetermined threshold (step S12: YES), the control device 50 determines whether the two-wheeled vehicle 120 is separated from the center of the obstacle in the left-right direction toward the host vehicle 1 side by a distance equal to or larger than the predetermined threshold, based on the recognition result of the recognition unit 51 (step S13). Specifically, as shown in FIG. 2, the control device 50 determines whether the distance D2 between the line L0 passing through the center of the preceding vehicle 110 in the left-right direction and the two-wheeled vehicle 120 on the host vehicle 1 side (here, the left side) is equal to or larger than the predetermined threshold.

When the two-wheeled vehicle 120 is not separated from the center of the obstacle in the left-right direction toward the host vehicle 1 side by a distance equal to or larger than the predetermined threshold (step S13: NO), specifically, when the distance D2 is less than the predetermined threshold, the two-wheeled vehicle 120 has a high probability of avoiding from the side opposite to the host vehicle 1 to the lateral side of the preceding vehicle 110. Accordingly, the control device 50 determines that the two-wheeled vehicle 120 does not enter the predicted trajectory L1 of the host vehicle 1, and ends the flowchart without performing the CMBS control.

When the two-wheeled vehicle 120 is separated from the center of the obstacle in the left-right direction toward the host vehicle 1 side by a distance equal to or larger than the predetermined threshold (step S13: YES), the control device 50 determines whether a host vehicle prediction position at a time point when the host vehicle 1 catches up with the two-wheeled vehicle 120 is within the jumping-out prediction area 150 (step S14). The host vehicle prediction position is a predicted position of the host vehicle 1 at the time point when the host vehicle 1 catches up with the two-wheeled vehicle 120. The host vehicle prediction position is calculated based on the travel speed, the acceleration, and the like of the host vehicle 1 detected by the vehicle state detection unit 20 and the travel speed, the acceleration, and the like of the two-wheeled vehicle 120 recognized by the recognition unit 51.

When the host vehicle prediction position is outside the jumping-out prediction area 150 (step S14: NO), the flowchart is ended without performing the CMBS control because a probability of the collision is low.

When the host vehicle prediction position is within the jumping-out prediction area 150 (step S14: YES), the control device 50 determines whether the distance D1 between the predicted trajectory L1 of the host vehicle 1 and the obstacle in the left-right direction is equal to or less than the predetermined threshold (step S15).

When the distance D1 between the predicted trajectory L1 of the host vehicle 1 and the obstacle in the left-right direction is larger than the predetermined threshold (step S15: NO), the control device 50 determines that the two-wheeled vehicle 120 does not enter the predicted trajectory L1 of the host vehicle 1, and ends the flowchart without performing the CMBS control.

When the distance D1 between the predicted trajectory L1 of the host vehicle 1 and the obstacle in the left-right direction is equal to or less than the predetermined threshold (step S15: YES), the control device 50 determines that a collision between the host vehicle 1 and the two-wheeled vehicle 120 is predicted (step S16). Then, the control device 50 performs the CMBS control, that is, notifies the driver and/or brakes the host vehicle 1 (step S17).

### Modification 1

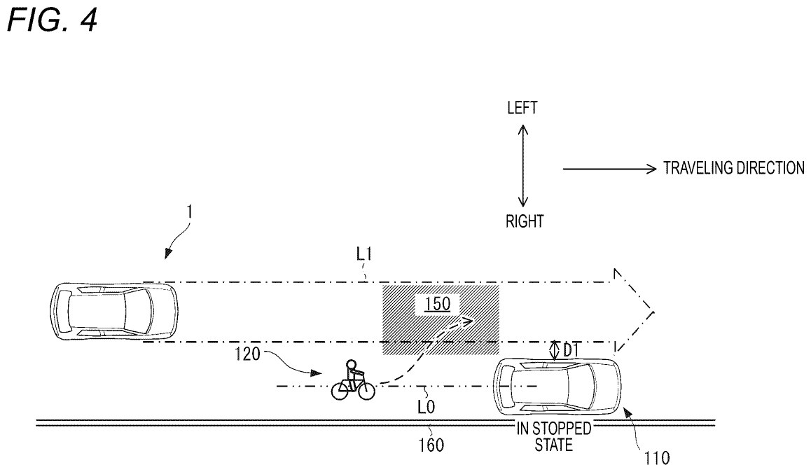

As shown in FIG. 4, for example, when the recognition unit 51 recognizes the presence of, for example, a guard rail 160 (or a curb and the like) on a side opposite to the host vehicle 1 with respect to the preceding vehicle 110 (for example, on a right side of the preceding vehicle 110), the control device 50 may determine that the two-wheeled vehicle 120 enters the predicted trajectory L1 of the host vehicle 1 regardless of a positional relationship between the two-wheeled vehicle 120 and the center of the obstacle in the left-right direction.

### Modification 2

When a driver of the two-wheeled vehicle 120 traveling just before an obstacle (the preceding vehicle 110) turns to the host vehicle 1 side (left side), the two-wheeled vehicle 120 has a high probability of avoiding the obstacle and moving to the host vehicle 1 side. The control device 50 may determine that the two-wheeled vehicle 120 enters the predicted trajectory L1 of the host vehicle 1 when the recognition unit 51 recognizes that the driver of the two-wheeled vehicle 120 turns to the host vehicle 1.

Although one embodiment of the present invention has been described above with reference to the accompanying drawings, it is needless to say that the present invention is not limited to the embodiment. It is apparent that those skilled in the art can conceive of various modifications and changes within the scope described in the claims, and it is understood that such modifications and changes naturally fall within the technical scope of the present invention. In addition, the constituent elements in the above embodiments may be freely combined without departing from the gist of the invention.

For example, in the above-described embodiments, the two-wheeled vehicle 120 is described as an example of a bicycle, but the two-wheeled vehicle 120 may be a motorcycle, an electric kickboard, or the like.

Further, the control device 50 may determine whether to perform the CMBS control, based on an amount of lateral movement of the two-wheeled vehicle 120 toward the host vehicle 1 side. For example, even in a case where the two-wheeled vehicle 120 is traveling on the side opposite to the host vehicle 1 with respect to the center of the obstacle in the left-right direction, when the two-wheeled vehicle 120 is laterally moving toward the host vehicle 1 side, the driver of the host vehicle 1 may be notified and/or the host vehicle 1 may be braked.

In the present specification, at least the following matters are described. In the parentheses, the corresponding constituent elements and the like in the above embodiment are shown as an example, but the present invention is not limited thereto.
(1) A vehicle control device including:
a recognition unit (recognition unit 51) configured to recognize surroundings of a host vehicle (host vehicle 1); and
a control unit (control unit 52) configured to perform at least one of notifying a driver of the host vehicle and braking the host vehicle when it is determined, from a recognition result of the recognition unit, that a two-wheeled vehicle (two-wheeled vehicle 120) and an obstacle (preceding vehicle 110) are present outside a predicted trajectory (predicted trajectory L1) of the host vehicle in front of the host vehicle and the two-wheeled vehicle is traveling toward the obstacle between the host vehicle and the obstacle.

According to (1), when the two-wheeled vehicle has a high probability of entering the predicted trajectory of the host vehicle, the driver of the host vehicle can be warned or appropriate deceleration assistance can be performed.
(2) The vehicle control device according to (1), in which
the control unit performs at least one of notifying the driver and braking the host vehicle when it is further determined that the two-wheeled vehicle is traveling at a first speed or higher.

According to (2), in a case where a speed of the two-wheeled vehicle is high, the two-wheeled vehicle cannot be stopped just before the obstacle and has a high probability of entering the predicted trajectory of the host vehicle, and thus the driver of the host vehicle can be warned in advance or appropriate deceleration assistance can be performed.
(3) The vehicle control device according to (1), in which
the control unit performs at least one of notifying the driver and braking the host vehicle when it is further determined that a deceleration required for the two-wheeled vehicle to stop with respect to the obstacle is equal to or larger than a first deceleration.

According to (3), when the two-wheeled vehicle cannot be stopped with respect to the obstacle unless the two-wheeled vehicle suddenly decelerates, the two-wheeled vehicle has a high probability of entering the predicted trajectory of the host vehicle, and thus in such a case, the driver of the host vehicle is warned in advance or appropriate deceleration assistance is performed.
(4) The vehicle control device according to any one of (1) to (3), in which
the control unit performs at least one of notifying the driver and braking the host vehicle when it is further determined that the two-wheeled vehicle is present within a predetermined range with respect to the obstacle.

According to (4), in a case where the two-wheeled vehicle is present within the predetermined range with respect to the obstacle, the two-wheeled vehicle has a high probability of entering the predicted trajectory of the host vehicle, and thus in such a case, the driver of the host vehicle can be warned in advance or appropriate deceleration assistance can be performed.
(5) The vehicle control device according to any one of (1) to (4), in which
the control unit performs at least one of notifying the driver and braking the host vehicle when it is further determined that the two-wheeled vehicle is traveling on a host vehicle side with respect to a center of the obstacle in a left-right direction.

According to (5), in a case where the two-wheeled vehicle is traveling on the host vehicle side with respect to the center of the obstacle in the left-right direction, the two-wheeled vehicle has a high probability of entering the predicted trajectory of the host vehicle, and thus in such a case, the driver of the host vehicle can be warned in advance or appropriate deceleration assistance can be performed.
(6) The vehicle control device according to any one of (1) to (5), in which
the control unit performs at least one of notifying the driver and braking the host vehicle when it is further determined that the host vehicle is traveling at a second speed or higher.

According to (6), in a case where a speed of the host vehicle is high, the two-wheeled vehicle and the host vehicle may excessively approach each other when the two-wheeled vehicle enters the predicted trajectory of the host vehicle, and thus in such a case, the driver of the host vehicle can be warned in advance or appropriate deceleration assistance can be performed.
(7) The vehicle control device according to (6), in which
the control unit performs at least one of notifying the driver and braking the host vehicle when it is further determined that a deceleration required for the host vehicle to stop with respect to the obstacle or a jumping-out prediction area (jumping-out prediction area 150) of the two-wheeled vehicle is equal to or larger than a second deceleration.

According to (7), in a case where the host vehicle cannot be stopped with respect to the obstacle or the jumping-out prediction area unless the host vehicle suddenly decelerates, the host vehicle and the two-wheeled vehicle may excessively approach each other, and thus in such a case, the driver of the host vehicle can be warned in advance or appropriate deceleration assistance can be performed.
(8) The vehicle control device according to any one of (1) to (7), in which
the control unit performs at least one of notifying the driver and braking the host vehicle when it is further determined that the host vehicle is present within a predetermined range with respect to the obstacle or a jumping-out prediction area of the two-wheeled vehicle.

According to (8), in a case where the host vehicle is present within the predetermined range with respect to the obstacle or the jumping-out prediction area, the host vehicle and the two-wheeled vehicle may excessively approach each other, and thus in such a case, the driver of the host vehicle can be warned in advance or appropriate deceleration assistance can be performed.
(9) The vehicle control device according to any one of (1) to (8), in which
the control unit performs at least one of notifying the driver and braking the host vehicle when it is further determined that a distance between the predicted trajectory of the host vehicle and the obstacle in a left-right direction is equal to or less than a predetermined threshold.

According to (9), in a case where the distance between the predicted trajectory of the host vehicle and the obstacle in the left-right direction is equal to or less than the predetermined threshold, the two-wheeled vehicle has a high probability of entering the predicted trajectory of the host vehicle when the two-wheeled vehicle avoids the obstacle, and thus in such a case, the driver of the host vehicle can be warned in advance or appropriate deceleration assistance can be performed.
(10) A vehicle control method including:
recognizing surroundings of a host vehicle (host vehicle 1); and
performing at least one of notifying a driver of the host vehicle and braking the host vehicle when it is determined, from a recognition result, that a two-wheeled vehicle (two-wheeled vehicle 120) and an obstacle (preceding vehicle 110) are present outside a predicted trajectory of the host vehicle in front of the host vehicle and the two-wheeled vehicle is traveling toward the obstacle between the host vehicle and the obstacle.

According to (10), when the two-wheeled vehicle has a high probability of entering the predicted trajectory of the host vehicle, the driver of the host vehicle can be warned or appropriate deceleration assistance can be performed.

### REFERENCE SIGNS LIST

1: host vehicle
51: recognition unit
52: control unit
110: preceding vehicle (obstacle)
120: two-wheeled vehicle
150: jumping-out prediction area
L1: predicted trajectory of host vehicle

What is claimed is:

1. A vehicle control device comprising:
a recognition unit configured to recognize surroundings of a host vehicle; and
a control unit configured to perform at least one of: notifying a driver of the host vehicle; and braking the host vehicle, in a case where a determination is made, from a recognition result of the recognition unit, that a two-wheeled vehicle and an obstacle are present outside a predicted trajectory of the host vehicle in front of the host vehicle and the two-wheeled vehicle is traveling between the host vehicle and the obstacle toward the obstacle.

2. The vehicle control device according to claim 1, wherein
the control unit performs at least one of: notifying the driver; and braking the host vehicle, in a case where a further determination is made that the two-wheeled vehicle is traveling at a first speed or higher.

3. The vehicle control device according to claim 1, wherein
the control unit performs at least one of: notifying the driver; and braking the host vehicle, in a case where a further determination is made that a deceleration required for the two-wheeled vehicle to stop with respect to the obstacle is equal to or larger than a first deceleration.

4. The vehicle control device according to claim 1, wherein
the control unit performs at least one of: notifying the driver; and braking the host vehicle, in a case where a further determination is made that the two-wheeled vehicle is present within a predetermined range with respect to the obstacle.

5. The vehicle control device according to claim 1, wherein
the control unit performs at least one of: notifying the driver; and braking the host vehicle, in a case where a further determination is made that the two-wheeled vehicle is traveling on the host vehicle's side relative to a center of the obstacle in a left-right direction.

6. The vehicle control device according to claim 1, wherein
the control unit performs at least one of: notifying the driver; and braking the host vehicle, in a case where a further determination is made that the host vehicle is traveling at a second speed or higher.

7. The vehicle control device according to claim 6, wherein
the control unit performs at least one of: notifying the driver; and braking the host vehicle, in a case where a further determination is made that a deceleration required for the host vehicle to stop with respect to the obstacle or a jumping-out prediction area of the two-wheeled vehicle is equal to or larger than a second deceleration.

8. The vehicle control device according to claim 1, wherein
the control unit performs at least one of: notifying the driver; and braking the host vehicle, in a case where a further determination is made that the host vehicle is present within a predetermined range with respect to the obstacle or a jumping-out prediction area of the two-wheeled vehicle.

9. The vehicle control device according to claim 1, wherein
the control unit performs at least one of: notifying the driver; and braking the host vehicle, in a case where a further determination is made that a distance between the predicted trajectory of the host vehicle and the obstacle in a left-right direction is equal to or less than a predetermined threshold.

10. The vehicle control device according to claim 2, wherein
the control unit performs at least one of: notifying the driver; and braking the host vehicle, in a case where a further determination is made that a distance between the predicted trajectory of the host vehicle and the obstacle in a left-right direction is equal to or less than a predetermined threshold.

11. The vehicle control device according to claim 3, wherein
the control unit performs at least one of: notifying the driver; and braking the host vehicle, in a case where a further determination is made that a distance between the predicted trajectory of the host vehicle and the obstacle in a left-right direction is equal to or less than a predetermined threshold.

12. The vehicle control device according to claim 4, wherein
the control unit performs at least one of: notifying the driver; and braking the host vehicle, in a case where a further determination is made that a distance between the predicted trajectory of the host vehicle and the obstacle in a left-right direction is equal to or less than a predetermined threshold.

13. The vehicle control device according to claim 5, wherein
the control unit performs at least one of: notifying the driver; and braking the host vehicle, in a case where a further determination is made that a distance between the predicted trajectory of the host vehicle and the obstacle in a left-right direction is equal to or less than a predetermined threshold.

14. The vehicle control device according to claim 6, wherein
the control unit performs at least one of: notifying the driver; and braking the host vehicle, in a case where a further determination is made that a distance between the predicted trajectory of the host vehicle and the obstacle in a left-right direction is equal to or less than a predetermined threshold.

15. The vehicle control device according to claim 7, wherein
the control unit performs at least one of: notifying the driver; and braking the host vehicle, in a case where a further determination is made that a distance between the predicted trajectory of the host vehicle and the obstacle in a left-right direction is equal to or less than a predetermined threshold.

16. The vehicle control device according to claim 8, wherein
the control unit performs at least one of: notifying the driver; and braking the host vehicle, in a case where a further determination is made that a distance between the predicted trajectory of the host vehicle and the obstacle in a left-right direction is equal to or less than a predetermined threshold.

17. A vehicle control method comprising:
recognizing surroundings of a host vehicle; and
performing at least one of: notifying a driver of the host vehicle; and braking the host vehicle, in a case where a determination is made, from a result of the recognizing, that a two-wheeled vehicle and an obstacle are present outside a predicted trajectory of the host vehicle in front of the host vehicle and the two-wheeled vehicle is traveling between the host vehicle and the obstacle toward the obstacle.
